(19) United States
(12) Patent Application Publication
(10) Pub. No.: US 2001/0014728 A1
(43) Pub. Date: Aug. 16, 2001

(54) Thermosetting coating composition

(76) Inventors: Kenji Aoki, Hiratsuka-shi (JP); Koji Hirano, Yokohama-si (JP); Tetsuya Yokoyama, Hiratsuka-shi (JP)

Correspondence Address: Donald W. Huntley, 1105 North Market Street, P. O. Box 948, Wilmington, DE, 19899-0948, US

(21) Appl. No.: 09/741,708

(22) Filed: Dec. 20, 2000

(30) Foreign Application Priority Data
Dec. 24, 1999 (JP) 11/365810

(51) Int. Cl. C08G 18/80; B32B 27/40; B32B 27/06; C08L 61/20; C09D 161/20; C09D 175/00; C08L 75/00; B32B 27/42; C08G 12/00

(52) U.S. Cl. 528/45; 525/452; 525/453; 525/509; 524/591; 524/612; 524/839; 524/840; 524/843; 428/425.8

(57) ABSTRACT

A thermosetting coating composition, which contains in active hydrogen group component base substance resin (A), amino resin curing agent (B), block polyisocyanate compound curing agent, (C) and acid catalyst (D).

### BACKGROUND OF THE INVENTION

In the past melamine and isocyanate curing components have been used for preparing thermosetting coating compositions. However each of these has presented certain drawbacks.

Melamine curing components are typically combined with polyol resin. However, the high curing temperatures required for these materials often results in distortion or cracking of the base material. Thus, the kinds of base material that can be used is limited.

In addition, the melamine cross-linking characteristics can adversely effect coatability, weather resistance of the resulting coating and finish coat adhesion. Previous attempts to deal with the high curing temperatures normally required for melamine coating compositions have included the addition of catalyst to the composition, such as para toluene sulfonic acid. However, such additives suffer the drawbacks of yellowing discoloration, and depreciation of weather resistance and mechanical properties.

Isocyanates have been used in thermosetting coating compositions, generally combined with polyol resin and block polyisocyanate curing agent. However, the block polyisocyanate curing type coating components share the same drawbacks as the melamine curing coating components noted above. In addition, organic tin catalyst is typically combined with the block polyisocyanate component as a disaggregation catalyst. This can lower the required baking temperature baked to around 160 degrees, but at a higher cost.

Melamine resin curing agent and block polyisocyanate curing agent can also be used jointly in polyol resin. However, the catalysts required to achieve low temperature curing generally result in unacceptably long curing times.

### SUMMARY OF THE INVENTION

The present invention provides coatings having superior performance characteristics, which can be cured by baking at low temperatures, for example, of about 140° C.

Specifically, the present invention provides thermosetting coating compositions comprising

(1) base resin selected from (a) active hydrogen group resin (A), and (b) blocked isocyanate resin (E);

(2) amino resin curing agent (B); and

(3) acid catalyst (D);

with the proviso that when the base resin is an active hydrogen group resin (A), the composition further comprises blocked polyisocyanate curing agent (C).

### DETAILED DESCRIPTION OF THE INVENTION

The active hydrogen group resin (A) of the present invention is a resin containing an active hydrogen group such as a hydroxyl group or a carboxyl group. Representative examples of these resins include a vinyl copolymer, a polyester resin, an alkyd resin, a fluoro resin, and a silicone resin. These resins can be used alone or in combination with a vinyl copolymer, a vinyl monomer with a hydroxyl group component, an ethylene unsaturated carboxylic acid, and an unsaturated monomer.

Representative examples of monomers which can be used to prepare active hydrogen group resin (A) include

(1) Vinyl monomers with a hydroxyl group component such as hydroxyethyl (meta) acrylate, hydroxypropyl (meta) acrylate, hydroxybutyl (meta) acrylate, (poly) ethylene glycol mono (meta) acrylate, (poly) propylene glycol mono (meta) acrylate, hydroxybutyl vinyl ether, (meta) alkyl alcohol and the reaction product of the above hydroxyl group component with a vinyl monomer and lactone compound such as β-propio lactone, dimethyl propio lactone, butyl lactone, γ-valero lactone, γ-capro lactone, γ-lauroyl lactone, ε-capro lactone, ε-capro lactone (such as that available from Daisel Chemistry Company under the brand name placcel FM 1), capro lactone degeneration (meta) acrylic acid hydroxyester group, (such as that available from Daisel Chemistry Company under the brand name placcel FM 2); capro lactone degeneration (meta) acrylic acid hydroxyester group, (such as that available from Daisel Chemistry Company under the brand name placcel FM 3); capro lactone degeneration (meta) acrylic acid hydroxyester group, (such as that available from Daisel Chemistry Company under the brand name placcel FA-1); capro lactone degeneration (meta) acrylic acid hydroxyester group (such as that available from Daisel Chemistry Company under the brand name placcel FA2); capro lactone degeneration (meta) acrylic acid hydroxyester group (such as that available from Daisel Chemistry Company under the brand name placcel FA3); capro lactone degeneration (meta) acrylic acid hydroxyester group) and the like.

(2) Ethylenically unsaturated carboxylic acids which can be used include: (meta) acrylic acid, maleic acid, and capro lactone degeneration carboxyl group component (meta) acryl monomers such as those available from Daisel Chemistry Company as placcel FM 1A, placcel FM 4A, and placcel FM 10A.

(3) Other non-saturated monomer which can be used include:

alkyl of C 1-18 of (meta) acrylic acid of (meta) acrylic acid cyclohexyl or cycloalkyl esters such as (meta) methyl acrylate, (meta) ethyl acrylate, (meta) acrylic acid propyl, (meta) butyl acrylate, (meta) acrylic acid hexyl, (meta) acrylic acid octyl, (meta) acrylic acid laurate, and the like, aromatic vinyl monomer group of styrene and the like, (meta) acrylic acid amide and the derivative group such as N-butoxy methyl (meta) acryl amide, (meta) acryl amide, N-methylol (meta) acrylamide, (meta) acrylonitrile and the like, alkokysilyl group component vinyl monomer groups such as γ-(meta) acryloxy propyl trimethoxy silane, γ-(meta) acryloxy propyl methyl dimethoxy silane, γ-(meta) acryloxy propyl triethoxysilane, vinyl trimethoxysilane, and the like.

A vinyl copolymer can be combined with the hydroxyl group component monomer in range of about 20-200 mg KOH/g of hydroxyl value of the copolymer. Generally, the hydroxyl group component monomer group as vinyl copolymer is used in an amount of about 3-40%, and preferably about 5-30%, based on the total weight of monomer.

Ethylenically unsaturated carboxylic acid as vinyl copolymer can be combined to provide about 20-200 mg KOH/g of acid value of the copolymer. Generally, the ethylenically unsaturated carboxylic acid as vinyl copolymer is used in amount of about 3-40%, and preferably about 5-30% based on the total weight of monomer. Generally, the other non-saturated monomer groups as vinyl copolymer are used in amounts of about 37-95%, preferably about 60-91% based on the total weight of monomer.

These components can be reacted by radical co-polymerization using well-known solution polymerization techniques.

The amino resin curing agent (B) used in the present invention can be prepared by well-known conventional methods. For example, the amino resin can be prepared by methylol degeneration of the amino resin. The amino constituent can be provided, for example, by reaction with aldehyde and an amino constituent such as melamine, urea, benzoguanamine, acetoguanamine, terrorism guanamine, spiro guanamine, and dicyandiamide. Representative aldehydes which can be used include, for example, formaldehyde, paraformaldehyde, acetaldehyde, and Daimler-Benz AG aldehyde.

In addition, etherification of the methylol degeneration amino resin with alcohol is used. Representative examples of alcohol S which can be used include ethyl alcohol, carbonyl, ethanol, n-propyl alcohol, i-propyl alcohol, n-butyl alcohol, i-butyl alcohol, 2-ethyl butanol, and 2-ethylhexanol.

The block polyisocyanate compound curing agent (C) which can be used in the present invention can be prepared by conventional techniques, such as blocking a well-known polyisocyanate with a blocking agent. Representative polyisocyanates which can be used include hexamethylene diisocyanate or an aliphatic diisocyanate of trimethyl hexamethylene diisocyanate; hydrogenation xylene diisocyanate or ringed aliphatic diisocyanate of isophorone diisocyanate; organic diisocyanate such as toluene diisocyanate, aromatic diisocyanate group of 4,4′-diphenyl-methane diisocyanate; the reaction product of organic diisocyanate and polyalcohol; the reaction product of organic diisocyanate, low molecular weight polyester resin and water; and the cyclic polymerization product of an organic diisocyanate and organic diisocyanate. Representative examples of such compounds being marketed include those available from Dainippon Ink & Chemicals company as Burnock D-750, Burnock D-800, Burnock DN-950, Burnock DN-970 and Burnock 15-455; those available from Bayer AG as Desmodur L, Desmodur N, Desmodur HL, Desmodur IL, and Desmodur N 3390; those available from Takeda Chemical Industries company as Takenate D-102, Takenate-202, Takenate-110 N, and Takenate 123 N; those available from Nippon Polyurethane Industry Company as Coronate L, Coronate HL, Coronate EH, and Coronate 203; and those available from Asahi Chemical Industry company as Duranate24A-90CX.

Of the foregoing, those polyisocyanates having an aliphatic diisocyanate group and a ringed aliphatic diisocyanate group are preferable.

The blocking agent used in the preparation of the blocked polyisocyanates can be a phenolic type, lactam type, active methylene type, alcohol type, mercaptan type, acid amide type, imide type, amine type, imidazole type, urea type, carbamate type, imine type or sulfite type, and the like.

The acid type catalyst (D) used in the present invention can be any of the known acid type catalysts, which conventionally promote condensation reactions with a functional group such as the methylol group. The carbamate group and the amino resin curing agent which block polyisocyanate curing agent (B) have an alkylation methylol group (low-grade alkyl derivative of methylol).

In addition, as an acid type catalyst (D), it is preferred that the carbamate group and amino resin curing agent use a catalyst having an acceleration effect on the reaction before a blocking agent separates from isocyanate upon baking or curing of a coating of the present invention. Representative examples of acid type catalyst (D) that can be used in the present invention include sulfuric acid, phosphoric acid, para toluenesulfonic acid and its derivatives, trichloroacetic acid, trifluoromethane sulfonic acid, phosphoric acid monobutyl, dibutyl phosphate, and boron trifluoride.

The components of the thermosetting coating compositions of the present invention can be generally in the range for the curing agent (B) of 5-100 parts by weight, preferably 15-50 parts by weight; for curing agent (C) of 5-100 parts by weight, preferably 10-50 parts by weight; for catalyst (D) of 0.001-10 parts by weight, preferably 0.1-1 parts by weights based on 100 parts by weight of resin (A).

A further embodiment of the present invention comprises coating compositions using, as a base resin, blocked isocyanate resin (E). This blocked isocyanate resin typically contains active hydrogen groups such as H and COOH and a blocked isocyanate group. The coating compositions of the present invention further comprise amino resin curing agent (B) and acid catalyst (D).

The blocked isocyanate base resin (E) can be prepared by reacting a half block polyisocyanate compound (the compound made by blocking one part of an isocyanate group of the above-described polyisocyanate compound with the blocking agent) with resin containing active hydrogen groups such as a hydroxyl group, or a carboxyl group (for example, vinyl copolymer, polyester resin, alkyd resin, fluororesin, and silicone resin).

The resin (E) can be prepared by radical copolymerization with a block isocyanate group having non-saturated group, that is, the compound made by blocking the isocyanate group of the described isocyanate group having non-saturated compound (isocyanato ethylacrylate, m-isopropenyl-a, a-dimethylbenzyl isocyanate, etc.), hydroxyl group component vinyl monomer, ethylenically unsaturated carboxylic acid, and the other non-saturated monomers. The specific choice will depend on the desired performance requirements, as will be evident to those skilled in the art. Radical copolymerization can be by well-known solution polymerization methods.

The blocked isocyanate component with a non-saturated group is used in amounts of about 10-40%, and preferably about 5-60% by weight based on the total monomer.

The thermosetting coating composition preferably comprises about 5-100 parts by weight of curing agent (B), preferably about 15-50 parts by weight of, catalyst (D), and generally about 0.001-10 parts by weight, preferably 0.1-1 parts by weight, of resin (E).

The thermosetting coating compositions of the present invention are typically formulated as water-based coatings by neutralizing, using a basic compound which is dispersed in water, the carboxyl group in the resin (A) or (E).

Representative examples of the basic compound are sodium hydroxide, potassium hydroxide, lithium hydroxide, calcium hydroxide, alkali metal of barium hydroxide or alkaline earth metal; ammonia; tertiary monoamines such as dimethylethanolamine, trimethylamine, triethylamine, trilsopropyl amine, methyldiethanolamine, and dimethylaminoethanol.

The coatings of the present invention can include conventional additives as needed, such as pigment, color, and flowability modifier. The coatings of the present invention can be formulated as gloss and matte finish paint.

The water-based thermosetting coating compositions of the present invention can be used in an anion type electrode deposition. The coatings of the present invention are particularly useful in the electro deposition painting of aluminum sash building materials, particularly for electrolysis coloration or no coloration anodic oxidation aluminum materials. The electrode deposition paint coat can be formed by dipping the aluminum materials in the electrode deposition paint bath, and then anion electro deposition coating in an amount sufficient to provide a cured film thickness of about 5-30 micron. The coated substrate is then taken out of the coating bath, and optionally washed with water. After storing at room temperature, a cured coating can be formed by baking, for example, at about 120-200° C. for about 20-40 minutes.

The curing of the coating compositions of the present invention is accelerated by the presence of a secondary carbamate group (—NHCOO—) in the blocked polyisocyanate curing agent. The carbamate group is generated from the reaction of the blocked polyisocyanate group and the hydroxyl group. The coatings of the present invention are typically cured at about 180° C. When reaching about 120° C., reaction with a carbamate group and a methylol group (derivative is included) is generated in the presence of acid type catalyst, resulting in the first stage of curing of the coating. Furthermore, the blocking agent volatilizes as the temperature rises, and the coating film is cross-linked by an addition reaction with the isocyanate group and hydroxy group of the base resin.

The coating compositions of the present invention provide coatings having a desirable combination of superior coating performance and superior mechanical properties and chemical resistance in the resulting cured films. In addition, the coating compositions of the present invention coating composition are generally not appreciably crosslinked below 50° C. Accordingly, the flow characteristics are stable, which results in superior film smoothness. The compositions can be effectively used for coating a wide variety of metallic and non-metallic substrates, including, for example, aluminum sash building materials.

The present invention is further illustrated by the following Examples and Comparative Examples, which are provided only for purposes of illustration, and should not be construed to limit the present invention.

### ACRYLIC COPOLYMER PREPARATION

Acrylic copolymer (a) was prepared by charging 70 g of isopropyl ethyl alcohol into a reaction vessel. The temperature was subsequently increased to 80° C., after which was added a mixture of 10 g styrene, 31 g methyl methacrylrate, 10 g n-butylacrylate, 30 g ethylacrylate, 12 g 2-hydroxyethylacrylate, 7 g acrylic acid and 2 g azobisdimethylvaleronitrile over a period of three hours. Subsequently, 1 g of azobisdimethylvaleronitrile was added, and this reaction mixture was held at 80° C. for one hour. to produce copolymer (a). The resulting copolymer (a) had a weight average molecular weight of about 20,000, an acid value of 55 mg KOH/g, and a hydroxyl value of 58 mg KOH/g.

This copolymer (a) was subsequently used for the preparation of high gloss electro-deposition paint.

Acrylic copolymer (b) was prepared by charging 70 g of isopropyl alcohol into a reaction vessel, and subsequently raising the temperature to 80 degrees C. A mixture of 10 g styrene, 24 g methyl methacrylate, 7 g γ-methacryloxy propyltrimethoxysilane, 10 g n-butylacrylate, 30 g ethylacrylate, 12 g 2-hydroxyethylacrylate, 7 g acrylic acid and 2 g azobisdimethylvaleronitrile was added over a period of three hours followed by doping with 1 g azobis-dimethylvaleronitrile at 80° C. for one hour, to produce copolymer (b). The resulting copolymer (b) had a 2.5 weight average molecular weight of about 10,000, an acid value of 55 mg KOH/g, and a hydroxyl value of 58 mg KOH/g.

This copolymer (b) was subsequently used for the preparation of matte finish electro-deposition paint.

Acrylic copolymer (c) was prepared by charging isopropyl alcohol into a reaction vessel, and subsequently raising the temperature to 80° C. A mixture of 10 g styrene, 24 g methyl methacrylate, 7 g ε-capro lactam block isocyanate ethylacrylate, 10 g n-butylacrylate, 30 g ethylacrylate, 12 g 2-hydroxyethylacrylate 7 g acrylic acid and 2 g azobisdimethylvaleronitrile was added over a period of three hours followed by doping with 1 g azobis-dimethylvaleronitrile at 80° C. for one hour, to produce copolymer (c). The resulting copolymer (c) had a 2.5 weight average molecular weight of about 10,000, an acid value of 55 mg KOH/g, and a hydroxyl value of 58 mg KOH/g

This copolymer (c) was subsequently used in the preparation of high gloss finish electro deposition paint.

### EXAMPLE 1

A gloss finish electro deposition paint was prepared using copolymer (a).

Triethylamine (0.4 equivalents based on the carboxyl groups of copolymer (a)) was combined with copolymer (a) 7 kg (an amount of solids content). This was admixed with 2 kg of methoxy melamine resin (available from Mitsui Cytec Co., Ltd. as Cymel 300), 1 kg blocked polyisocyanate compound (available from Asahi Chemical Industry Co., Ltd as Duranate 24A-90CX), and 50 g para toluenesulfonic acid 50 g, while agitating. Deionized water was added during the admixing. The pH was subsequently adjusted with triethylamine to 8.0, to give a high gloss electrodeposition paint having a solids content of 10 weight %.

### EXAMPLE 2

A matte finish electro deposition paint was prepared using copolymer (b).

Triethylamine (0.4 equivalents based on the carboxyl groups of copolymer (b)) was combined with copolymer (b) 7 kg (an amount of solids content). This was admixed with and dispersed in the mixture of 2 kg of Nikalac MX-430 (a melamine resin having abut 3 methyl groups and about 3 butyl groups per one triazine nucleus, and containing about 57% of the mononuclear compound, Trade name, marketed by Sanwa Chemical Co., Ltd.) Duranate 24A-90CX (Asahi Chemical Industry Co., Ltd., brand name, block polyisocyanate compound) 1 kg, para toluenesulfonic acid 50 g, while agitating.

Deionized water was added during the admixing. The pH was subsequently adjusted with triethyleamine to 8.0, to give a matte finish electrodeposition paint having a solids content of 10 weight %.

### EXAMPLE 3

In Example 3, the general procedure of Example 1 was repeated, except that copolymer (c) was used in place of copolymer (a).

### COMPARATIVE EXAMPLE 1

The procedures of Example 1 were repeated, except that acid catalyst was not used at all. A clear gloss electro deposition paint was obtained.

### COMPARATIVE EXAMPLE 2

The procedures of Example 2 were repeated, except that acid catalyst was not used at all. A clear matte finish electro deposition paint was obtained.

The paints prepared according to the Examples and Comparative Examples were coated onto substrates by electrodeposition techniques, using procedures with and without water rinse. According to these techniques, the paints describe above were used as electrodeposition baths. Aluminum substrates were coated. The aluminum (anodic oxidation aluminum) substrates were about 1 inch long and 0.1 m wide×thickness 0.5 mm, and bearing a coating of alumite 10 microns in thickness,. These substrates were immersed in the electrodeposition bath and treated using conventional electrodeposition techniques. The samples were removed from the electrodeposition bath. A coating of 10 μm was on the surface. The samples were hung to dry in an atmosphere of 70% humidity and a temperature of 20° C. for about 2 minutes, or until the coating did not drip and was set. The samples were then baked at a temperature of 140° or 170° C. for 30 minutes to cure the coating.

### EXAMPLES 1, 2 AND 3 AND COMPARATIVE EXAMPLES WERE RINSED

After anion electro coating by the method described above, the resulting coated substrate is raised from the bath, rinsed with water maintained at 20° C., and subsequently baked at a temperature of 140° or 170° C. for 30 minutes to cure the coating.

### EXAMPLE 4 (USING PAINT FROM EXAMPLE 1 WITHOUT A RINSE)

The general procedure of Example 1 was repeated, except that the coated substrate was not rinsed with water. After anion electro coating by the method described above, the coated substrate was raised from the bath, and subsequently baked at a temperature of 140° C. or 170° C. for 30 minutes to cure the coating.

The samples from the Examples and Comparative Examples were evaluated according to the following techniques, and the results summarized in Table 1.

Specular reflectivity:

60 degrees specular reflectivity according to JISK-5400

Smoothness:

Coating film surface:

evaluated visually for observation of orange peel, convex or concave surface and rated:

5—very good, 4—good, 3—inferior, 2—markedly inferior

Adhesion:

On the coated surface are formed 100 1 mm squares by use of a square cutter. An adhesive cellophane tape is adhered to the squares, followed by strongly peeling the tape to observe squares remaining without being peeled off.

Pencil scratch value:

Evaluated according to standard test JISK5400.

Alkali resistance:

A sample is dipped in a 1% NaOH aqueous solution at 20° C. for 160 hours to observe blister of the film, and rated:

5—very good, 4—good, 3—inferior, 2—markedly inferior

Acid resistance:

A sample is dipped in a 5% H₂SO₄ aqueous solution at 20° C. for 160 hours to observe blistering of the film and rated:

5—very good, 4—good, 3—inferior, 2—markedly inferior

TABLE 1

| | | | | | | | | | Comparative | | Comparative | |
|---|---|---|---|---|---|---|---|---|---|---|---|---|
| | Example 1 | | Example 2 | | Example 3 | | Example 4 | | Example 1 | | Example 2 | |
| Baking | 140° C. | 170° C. | 140° C. | 170° C. | 140° C. | 170° C. | 140° C. | 170° C. | 140° C. | 170° C. | 140° C. | 170° C. |
| Temperature | | | | | | | | | | | | |
| Specular | 90 | 92 | 12 | 14 | 89 | 91 | 92 | 93 | 90 | 92 | 11 | 14 |
| reflectivity | | | | | | | | | | | | |
| Smoothness | 5 | 5 | 5 | 5 | 5 | 5 | 5 | 5 | 4 | 5 | 4 | 5 |
| Adhesion | 5 | 5 | 5 | 5 | 5 | 5 | 5 | 5 | 5 | 5 | 5 | 5 |
| properties | | | | | | | | | | | | |
| Pencil scratch | 4H | 4H | 4H | 4H | 4H | 4H | 4H | 4H | H | 3H | H | 3H |
| value | | | | | | | | | | | | |
| Alkali | 4 | 5 | 5 | 5 | 4 | 5 | 4 | 5 | 2 | 3 | 2 | 3 |
| Resistance | | | | | | | | | | | | |
| Properties | | | | | | | | | | | | |
| Acid | 4 | 5 | 5 | 5 | 4 | 5 | 4 | 5 | 2 | 3 | 2 | 3 |
| resistance | | | | | | | | | | | | |
| Properties | | | | | | | | | | | | |

| | | | | | | |
|---|---|---|---|---|---|---|
| Paint Method | Rinse | Rinse | Rinse | Rinse | Rinse | No Rinse |

What is claimed is:

1. A thermosetting coating composition, comprising
(1) base resin selected from (a) active hydrogen group resin (A), and (b) blocked isocyanate resin (E);
(2) amino resin curing agent (B); and
(3) acid catalyst (D);
with the proviso that when the base resin is an active hydrogen group resin (A), the composition further comprises blocked polyisocyanate curing agent (C).

2. A water-based coating composition comprising a thermosetting coating composition of claim 1.

3. A thermosetting coating composition of claim 1 wherein the base resin is blocked isocyanate resin (E).

4. An anionic electrodeposition paint composition comprising a thermosetting composition of claim 1.

5. An aluminum sash building material coated with a coating composition of claim 1.
